(19) United States
(12) Patent Application Publication
(10) Pub. No.: US 2009/0147368 A1
(43) Pub. Date: Jun. 11, 2009

(54) Method for manufacturing wafer scale lens assembly and wafer scale lens assembly manufactured by the same

(75) Inventors: Hye Ran Oh, Suwon (KR); In Cheol Chang, Seongnam (KR); Seok Cheon Lee, Suwon (KR); Young Su Jin, Yongin (KR); Cheong Hee Lee, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/314,451

(22) Filed: Dec. 10, 2008

(30) Foreign Application Priority Data
Dec. 10, 2007 (KR) 10-2007-0127687

(51) Int. Cl. G02B 27/12

(52) U.S. Cl. 359/622

(57) ABSTRACT

A method for manufacturing a wafer scale lens assembly, and a wafer scale lens assembly manufactured by the same are disclosed. The method includes forming a plurality of transmissive regions and a plurality of non-transmissive regions on an object-side surface or an image-side surface of each of first and second lens substrates, forming a plurality of lens elements having refractive power on at least one of the object-side surface and the image-side surface of each of the first and second lens substrates, and stacking the first and second lens substrates, with a spacer interposed between the first lens substrate and the second lens substrate. Accordingly, image quality is improved by preventing undesired light from forming an image on an image plane of an image sensor. The process time is reduced to reduce a manufacturing cost.

### CROSS-REFERENCE TO RELATED APPLICATIONS

This application claims the priority of Korean Patent Application No. 2007-127687 filed on Dec. 10, 2007, in the Korean Intellectual Property Office, the disclosure of which is incorporated herein by reference.

### BACKGROUND OF THE INVENTION

1. Field of the Invention

The present invention relates to a method for manufacturing a wafer scale lens assembly, and a wafer scale lens assembly manufactured by the same.

2. Description of the Related Art

An early mobile communication terminal only had a communication function. However, services the mobile communication terminal provides, such as a image capturing service or a video transmission or communication service, have been diversified as the use thereof has increased. Functions and services of the mobile communication terminal are being continuously developed. Recently, a so-called camera phone or camera mobile phone has received much attention, which is a new convergence mobile communication terminal adopting both a digital camera technology and a mobile phone technology.

Particularly, there have been strong demands for smaller, lighter and lower-cost optical systems used for the camera phone.

As the camera phone market grows larger, smaller, lighter and lower-cost lenses are demanded. A wafer scale lens has been developed in order to mass produce low-priced lenses.

Unlike a general injection lens, the wafer scale lens is advantageous in that one lens assembly can be implemented by stacking and bonding a plurality of lens at the same time, without separate assembly processes.

FIG. 1 is across-sectional view of a lens assembly using a general wafer scale lens.

As shown in FIG. 1, a lens assembly 1 using the wafer scale lens includes a first lens 10 and a second lens 20 that are stacked and bonded together.

The first lens 10 includes a first lens substrate 13 formed of a transparent glass material, first and second lens elements 11 and 12 respectively disposed on top and bottom surfaces of the first lens substrate 13, and a lower partition wall 14 surrounding the second lens element 12.

The second lens 20 includes a second lens substrate 23, first and second lens elements 21 and 22 respectively disposed on top and bottom surfaces of the second lens substrate 23, and an upper partition wall 24 surrounding the second lens element 22.

To stack the first and second lens bodies 10 and 20, an adhesive agent 30 is applied on a top surface of the lower partition wall 14. The upper partition wall 24 of the second lens body 20 is stacked and bonded on the top surface of the lower partition wall 14, thereby completing the lens assembly 1.

The lens assembly 1 manufactured using the related art method may facilitate mass production and lower the manufacturing cost, but undesirably degrades the quality of an image as well as optical performance.

The image quality is degraded because a portion of light incident through an object-side lens surface of the first lens element 11 is undesirably incident onto an image plane of an image sensor, causing a flare phenomenon or diffuse-reflection, which is refraction of light by a substrate or a partition wall.

### SUMMARY OF THE INVENTION

An aspect of the present invention provides a method for manufacturing a wafer scale lens assembly, which can improve the quality of an image by preventing light from undesirably forming an image on an image plane of an image sensor, and can reduce a process time to save a manufacturing cost.

According to an aspect of the present invention, there is provided a method for manufacturing a wafer scale lens assembly, including: forming a plurality of transmissive regions and a plurality of non-transmissive regions on an object-side surface or an image-side surface of each of first and second lens substrates; forming a plurality of lens elements having refractive power on at least one of the object-side surface and the image-side surface of each of the first and second lens substrates; and stacking the first and second lens substrates, with a spacer interposed between the first lens substrate and the second lens substrate.

Each transmissive region may be provided as a circular opening having a predetermined inner diameter, and each non-transmissive region may be provided as a rectangular pattern, and have the the circular opening therein.

The circular opening may be off to one side in the non-transmissive region.

Each non-transmissive region may have four rounded corners.

Each transmissive region may be provided as a circular opening having a predetermined inner diameter, and each non-transmissive region may be provided as a polygonal pattern and have the circular opening therein.

The non-transmissive region may be formed of a dull material.

The spacer may be adhered by a photo-curable adhesive agent between the image-side surface of the first lens substrate and the object-side surface of the second lens substrate.

The non-transmissive region may be spaced apart from an adjacent non-transmissive region at an interval of about 300 μm or longer.

The method may further include cutting the first and second lens substrates along a cutting line passing through a center of the interval between the adjacent non-transmissive regions.

According to another aspect of the present invention, there is provided a wafer scale lens assembly manufactured by the above method.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a lens assembly using a general wafer scale lens;

FIGS. 2A through 2D are views illustrating a method for manufacturing a wafer scale lens assembly, according to an exemplary embodiment of the present invention;

FIG. 3 is a plan view of first and second lens substrates used to manufacture a wafer scale lens assembly according to an exemplary embodiment of the present invention;

FIG. 4 is a view illustrating a lens optical system using a wafer scale lens assembly according to an exemplary embodiment of the present invention; and

FIG. 5 is a plan view illustrating first and second lens substrates used to manufacture a wafer scale lens assembly according to another exemplary embodiment of the present invention.

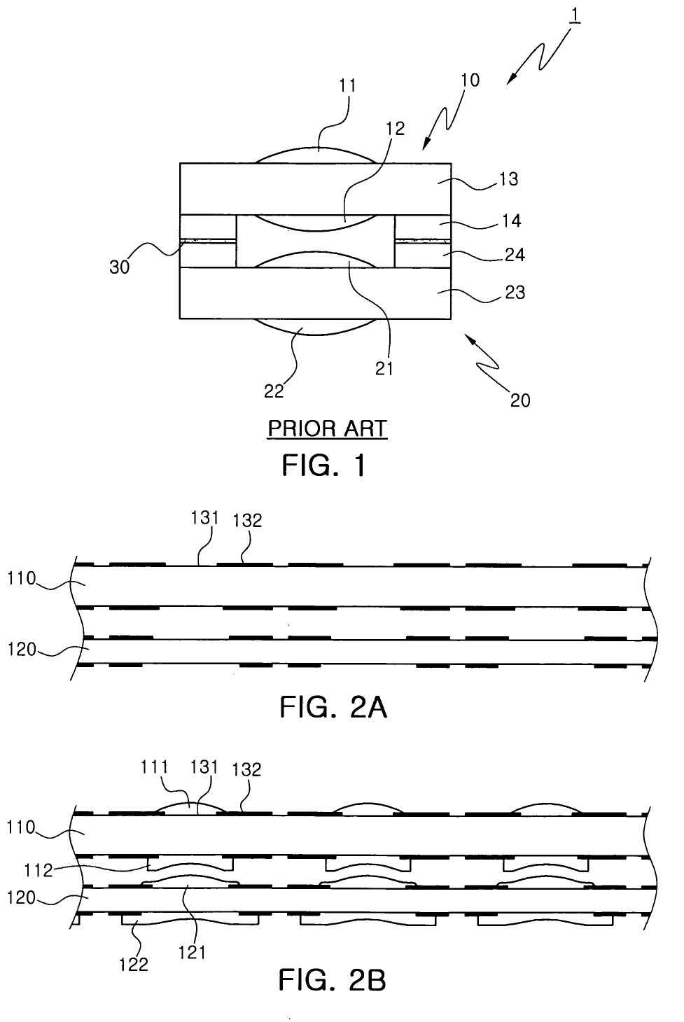

### DETAILED DESCRIPTION OF THE PREFERRED EMBODIMENT

Exemplary embodiments of the present invention will now be described in detail with reference to the accompanying drawings.

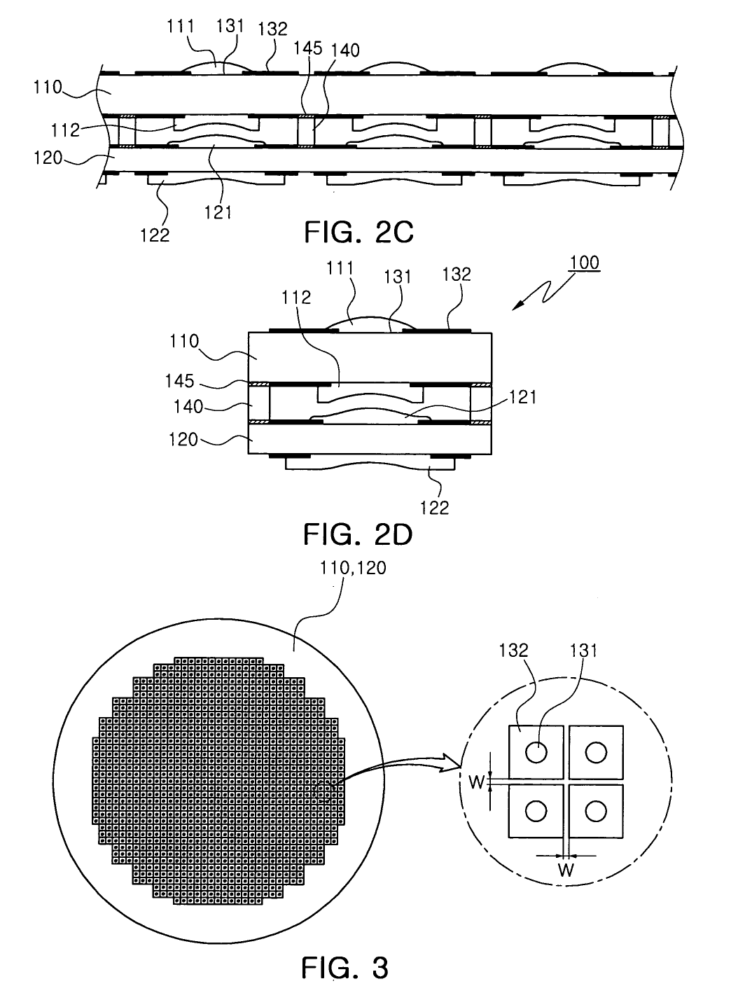

FIGS. 2A through 2D are views illustrating processes for manufacturing a wafer scale lens assembly according to an exemplary embodiment of the present invention.

A method for manufacturing a wafer scale lens assembly according to the exemplary embodiment of the present invention will now be described. As shown in FIG. 2A, a first lens substrate 110 and a second lens substrate 120 are provided. Each of the first and second lens substrate 110 and 120 is a transparent substrate formed of a glass material.

Each of the first and second lens substrates 110 and 120 has a plurality of transmissive regions 131 and a plurality of non-transmissive regions 132 formed at an object-side surface (an upper surface in the drawing) and an image-side surface (a lower surface in the drawing). Here, the transmissive region 131 means a portion through which light can pass, and the non-transmissive region 132 means a portion through which no light can pass. The transmissive region 131 and the non-transmissive region 132 may be formed at one of the object-side surface and the image-side surface.

The transmissive region 131 is provided in the form of a circular opening having a predetermined inner diameter. The non-transmissive region 132 is provided as a rectangular pattern or an arbitrary polygonal pattern on a surface of each of the first and second lens substrates 110 and 120. The circular opening is placed at the center of the rectangular pattern. However, the position of the circular opening is not limited to the center of the non-transmissive region. Alternatively, the circular opening may be off to one side.

The non-transmissive region 132 may be formed of a dull material to prevent a flare phenomenon caused by diffuse-reflection of light which is made incident from the outside.

The transmissive region 131 is formed as the circular opening having the same diameter as an effective diameter. Thus, effective light is not undesirably cut off in a rotational symmetric optical system. The non-transmissive regions 132 each formed as the rectangular pattern allows formation of a maximum number of patterns on one lens substrate.

Here, the non-transmissive region may be formed as a circular pattern or a polygonal pattern to thereby form a maximum bonding area and effectively prevent reflection, refraction, or incidence of undesirable light.

The non-transmissive region 132 may be formed by integrally disposing a photoresist layer on each of the first and second lens substrates 110 and 120. The photoresist layer may be formed of a resin composition such as a black photo-resist.

The photoresist layer used for the non-transmissive region 132 has high hydrophilicity and thus high adhesiveness with respect to a UV-curable polymer. Therefore, there is no need to separately form an adhesive layer on the photoresist layer.

As shown in FIG. 3, the first and second lens substrates 110 and 120 each are transparent wafer substrates each including the plurality of transmissive regions 131 and the plurality of non-transmissive regions 132.

As shown in FIG. 2B, a plurality of lens elements 110 and 112 having refractive power are respectively formed on the object-side surface and the image-side surface of the first substrate 110 including the transmissive and non-transmissive regions 131 and 132. Also, a plurality of lens elements 121 and 122 having refractive power are respectively formed on the object-side surface or the image-side surface of the second substrate 120 including the transmissive and non-transmissive regions 131 and 132. However, the plurality of lens elements may be formed on at least one of the object-side surface and the image-side surface of each of the first and second substrates 110 and 120.

To form the lens elements on the first and second lens substrates 110 and 120, a photo-curable resin is applied on the object-side surface or the image-side surface of each of the first and second lens substrates 110 and 120. Thereafter, a lens mold (not shown) having a lens cavity therein and serving as an upper mold is placed onto each of the first and second substrates 110 and 120 serving as a lower mold.

In this state, UV light is emitted to each of the first and second lens substrates 110 and 120 to cure the photo-curable resin between the lens mold and each of the first and second lens substrates 110 and 120, thereby molding the lens elements 111 and 121 having a spherical or aspherical surface.

In the first substrate 110, the non-transmissive region 132 is interposed between a corresponding one of the lens elements 111 and 112 and a corresponding surface of the first substrate 110. In the second substrate 120, the non-transmissive region 132 is also interposed between a corresponding one of the lens elements 121 and 122 and a corresponding surface of the second substrate 120. Optical axes of the lens elements 111, 112, 121 and 122 coincide with the center of a corresponding transmissive region 131 formed as a circular opening.

AS shown in FIG. 2C, the separately manufactured first and second lens substrates 110 and 120 are stacked together, with spacers 140 disposed therebetween.

The first and second lens substrates 110 and 120 are stacked such that optical axes of the lens elements 111, 112, 121 and 122 coincide with each other and with the center of an image plane IP of an image sensor.

The spacers 140 with the same length are used in order to maintain a-constant vertical interval between the first and second lens substrates 110 and 120 or a constant vertical interval between the second lens substrate 120 and the image plane IP of the image sensor.

The spacer 140 is a support member adhered by a photo-curable adhesive agent between the image-side surface of the first lens substrate 110 and the object-side surface of the second lens substrate 120 or between the image-side surface of the second lens substrate 120 and the image sensor.

The non-transmissive region 132 is spaced apart from an adjacent non-transmissive region 132 at an interval W of at least about 300 μm, thereby forming an opening region through which UV light passes. The photo-curable agent 140 is cured using the UV light passing through the interval W. Therefore, the photo-curing process can reduce the process time, compared to a thermal-curing process.

After the photo-curable agent 140 is cured by the UV irradiation, the first and second lens substrates 110 and 120 are cut along a virtual cutting line passing the center of the interval W between the adjacent non-transmissive regions 132. Consequently, as shown in FIG. 2D, wafer scale lens assemblies 110 can be mass-produced, each of which includes a first substrate 110, a second substrate 120, lens elements 111 and 112 respectively formed on an object-side surface and an image-side surface of the first substrate 110, lens elements 121 and 122 respectively formed on an object-side surface and an image-side surface of the second substrate 120, transmissive and non-transmissive regions 131 and 132 formed on the object-side surface and the image-side surface of each of the first and second lens substrates 110 and 120 to control the quantity of light, and spacers 140 maintaining the interval between the first and second lens substrates 110 and 120.

The interval W between the adjacent non-transmissive regions 132 is at least 300 μm, and an area occupied by the spacers 140 supporting the stack structure between the first and second lens substrates 110 and 120 is at about 100 μm or greater. Accordingly, a stable stack state can be maintained between the first and second lens substrates 110 and 120.

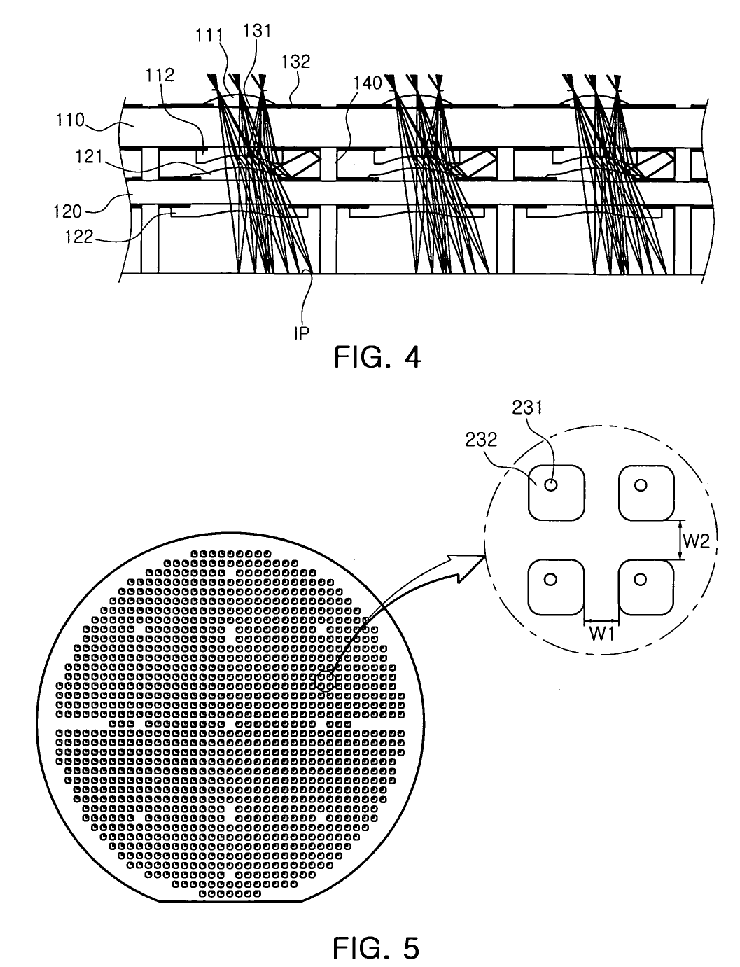

That is, the wafer scale lens assembly 110 is manufactured by the following process: patterning the non-transmissive regions 132 formed of a dull material on the object-side surface and the image-side surface of each of the first and second lens substrates 110 and 120 and simultaneously forming the respective transmissive regions 131 in the center of each of the non-transmissive regions 132, forming the lens elements 111, 112, 121 and 122 on at least one surface of each of the first and second lens substrates 110 and 120, and then stacking the first and second substrates 110 and 120 including the lens elements with the spacers 140 interposed therebetween. As shown in FIG. 4, when light is made incident onto this wafer scale lens assembly 110, only the desired light is incident through the transmissive regions 131 formed on the first lens substrate 110, and undesired light is cut off by the non-transmissive regions 132. Accordingly, the flare phenomenon caused by internal total reflection can be prevented, and the quality of an image formed on the image plane IP can be improved.

According to the present invention, transmissive regions and non-transmissive regions are patterned on each of the first and second lens substrates, so that undesired light is cut off and prevented from forming an image on the image plane, and thus the flare phenomenon can be prevented.

According to the present invention, the failure cost can be saved because the patterning of the non-transmissive and transmissive regions on the wafer level lens substrate is performed at an initial stage of a manufacturing process.

According to the present invention, a photo-curable agent is used as an adhesive agent between the lens substrate and the spacer, and cured by the UV light incident through an interval between adjacent non-transmissive regions. Therefore, the process time is reduced compared to using a thermal-curable agent as the adhesive agent, and this can contribute to reducing a manufacturing cost.

FIG. 5 is a plan view illustrating first and second lens substrates used to manufacture a wafer scale lens assembly according to another exemplary embodiment of the present invention.

As shown in FIG. 5, non-transmissive regions 232 have transmission regions 231 therein. Here, each of the transmissive regions 231 is off to one side.

The non-transmissive region 232 is provided as a rectangular pattern with four rounded corners.

The shape of the non-transmissive region 232 is designed to form a maximum bonding area and effectively prevent reflection, refraction, or incidence of undesirable light according to the designer's intentions.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for manufacturing a wafer scale lens assembly, the method comprising:
forming a plurality of transmissive regions and a plurality of non-transmissive regions on an object-side surface or an image-side surface of each of first and second lens substrates;
forming a plurality of lens elements having refractive power on at least one of the object-side surface and the image-side surface of each of the first and second lens substrates; and
stacking the first and second lens substrates, with a spacer interposed between the first lens substrate and the second lens substrate.

2. The method of claim 1, wherein each transmissive region is provided as a circular opening having a predetermined inner diameter, and each non-transmissive region is provided as a rectangular pattern and has the the circular opening therein.

3. The method of claim 2, wherein the circular opening is off to one side in the non-transmissive region.

4. The method of claim 2, wherein each non-transmissive region has four rounded corners.

5. The method of claim 1, wherein each transmissive region is provided as a circular opening having a predetermined inner diameter, and each non-transmissive region is provided as a polygonal pattern and has the circular opening therein.

6. The method of claim 1, wherein the non-transmissive region is formed of a dull material.

7. The method of claim 1, wherein the spacer is adhered by a photo-curable adhesive agent between the image-side surface of the first lens substrate and the object-side surface of the second lens substrate.

8. The method of claim 1, wherein the non-transmissive region is spaced apart from an adjacent non-transmissive region at an interval of about 300 μm or longer.

9. The method of claim 1, further comprising cutting the first and second lens substrates along a cutting line passing through a center of the interval between the adjacent non-transmissive regions.

10. A wafer scale lens assembly manufactured by the method of claim 1.
